(19) United States
(12) Patent Application Publication
(10) Pub. No.: US 2025/0281966 A1
(43) Pub. Date: Sep. 11, 2025

(54) HOT FORGING AND PRESS HARDENING TOOL AND METHOD FOR OPERATING THE SAME

(71) Applicant: BENTELER Mechanical Engineering GmbH, Bielefeld (DE)

(72) Inventors: Lars HIEGEMANN, Warendorf (DE); Robert STOCKTER, Hannover (DE)

(21) Appl. No.: 19/072,976

(22) Filed: Mar. 6, 2025

(30) Foreign Application Priority Data
Mar. 7, 2024 (EP) 24162104.4

(51) Int. Cl. B21J 13/00

(52) U.S. Cl. CPC B21J 13/00

(57) ABSTRACT

The present disclosure relates to a hot forging and press hardening tool, having an upper tool and a lower tool, which is able to be moved towards one another in a press stroke direction, wherein a mold cavity is formed between the upper tool and the lower tool in the closed state, and cooling channels for the passage of a cooling medium are formed in the upper tool and/or lower tool, wherein at least one cutting tool which is able to be moved relative to the upper tool is arranged on the upper tool, and the cutting tool has at least one cooling channel for temperature control and/or in that the cutting tool has a forming surface oriented in the press stroke direction and a cutting edge lying there behind in the press stroke direction and/or adjacent to the forming surface.

### RELATED APPLICATIONS

The present application claims priority of European Application Number 24162104.4 filed Mar. 7, 2024, the disclosure of which is hereby incorporated by reference herein in its entirety.

### FIELD

The present disclosure relates to a hot forging and press hardening tool.

The present disclosure further relates to a method.

### BACKGROUND

Sheet steel blanks are made by hot forging and press hardening, and used in the automotive industry, which are heated to a temperature above the austenitization temperature, i.e. above the Ac3 temperature, which is normally more than 900° C. The thus heated blank is placed in a hot forging tool and formed while still warm. The forming properties are good in terms of freedom of shape. Once the forging process has been completed, at least partially, or for example completely, the component thus produced is left in the hot forging tool and further quenched. In this case, the component is brought to a temperature in a short time so that the austenite previously formed due to the austenitization temperature is at least partially converted into martensite. In this way, tensile strengths Rm of greater than 1000 MPa, for example, more than 1250 MPa, more than 1400 MPa are achieved in the component. For example, a quenching temperature is chosen that is greater than 27 K/s. When the final temperature is reached, for example below 300° C., for example, below 200° C., the hard component produced in this way is then removed from the hot forging tool.

These components are able to be processed mechanically or by cutting technology. For example, a cutting operation is carried out during hot forging and/or after completion of the hot forging process or the press hardening process.

For example, such a manufacturing process is described in DE 10 2011 116 714 A1. The forging process is carried out with a forming tool segment. Subsequently, a separating slide is activated, which separates the formed component in the closed hot forging tool.

### SUMMARY

The object of the present disclosure is to optimize the degrees of forming freedom as well as the optimization of the trimming process, taking into account thermal losses during the forging process, compared to large-scale production.

The aforementioned object is achieved according to the present disclosure.

A part of the object related to the method is attained according to the present disclosure.

The hot forging and press hardening tool has an upper tool and a lower tool. The upper tool and lower tool is able to be moved towards each other in the press stroke direction. The press stroke direction corresponds to a vertical direction. When closed, a mold cavity remains between the upper tool and the lower tool. In this mold cavity, the previously inserted sheet metal blank or sheet steel blank is then formed into the component. The closed hot forging and press hardening tool lies with the upper tool and lower tool on the whole surface on the formed component. In order to carry out a press hardening process after the hot forging process, cooling channels for the passage of a cooling medium are formed in the upper tool and the lower tool. Already during, or at the latest after completion of the forging process, a cooling medium is passed through the tool in order to quench harden the formed component.

Furthermore, at least one cutting tool that is able to be moved relative to the upper tool is arranged in the upper tool.

According to the present disclosure, the forming of hot forging and press hardening tools is now characterized in that the cutting tool itself has at least one cooling channel. This cooling channel is controlled separately from the cooling channels in the upper tool and lower tool. With the help of this at least one cooling channel, the cutting tool is able to be individually tempered. Corresponding supply and discharge lines are provided on the cutting tool. According to the present disclosure, a temperature between 500° C. and 700° C. is set at the cutting edge of the component during trimming. By further cooling after trimming, the trimmed edge on the component is then also be to be press hardened accordingly.

Alternatively or additionally, the present disclosure is characterized in that the cutting tool has a forming surface oriented in the press stroke direction and a cutting edge located there behind in the press stroke direction and/or adjacent to the forming surface. The cutting edge is thus formed on the cutting tool itself. A sheet steel blank placed on a hold-down device or on the lower tool is thus initially formed by the forming surface of the cutting tool when the hot forging and press hardening tool is closed in the press stroke direction. For example, with the tempering of the cutting tool, there is no cooling at the beginning of the forging process that is so strong that press hardening would take place. Only when the hot forging tool is at the lower dead center, the cutting movement is carried out. Another significant advantage is that the forming surface on the cutting tool itself provides greater accuracy in relation to the cutting line or cutting contour to be created. Since the cutting tool is also involved, in the forging process itself, the geometric position with regard to the precision of the cutting tool is optimal for the trimming that is then carried out immediately after the forming. The cutting tool thus pre-centers the cutting edge.

For this purpose, the cutting tool is designed, for example, as an elongated tool and is arranged, for example, in an edge region of the upper tool. For example, in at least one embodiment of the present disclosure, elongated motor vehicle components, such as motor vehicle pillars, for example an A-pillar or B-pillar, are able to be trimmed with the highest precision, at least in a partial region. At the same time, however, not only the cutting geometry but also the material properties set in the region of the resulting cutting edge on the component are optimized due to the tempering of the cutting tool and the associated possibility of controlling the microstructure transformation during the press hardening process.

Furthermore, a cutting edge is formed on the lower tool, which cutting edge corresponds to the cutting edge of the cutting tool and then carries out a trimming due to the relative movement of the cutting tool relative to the lower tool. For example, the lower tool is firmly coupled to a lower press table. The cutting edge of the lower tool is able to be formed already and directly on the lower tool. However, the cutting edge of the lower tool is able to be designed as an insert or segment. If, for example, the cutting edge of the lower tool were to wear out, the lower tool is able to be replaced so that a high level of accuracy of a trimming edge is achieved.

The forming surface of the cutting tool itself is, for example, a rounded edge. For example, if the cutting tool is arranged on an outer edge region of the upper tool, an edge region of the component to be formed is bent corresponding to the lower tool according to the principle of deep drawing or bending. The forming surface is able to be designed variably or change over the length of the cutting tool. The forming surface is therefore not a radius that is constant in the longitudinal direction of the cutting tool. Different radius chamfers or forming surfaces are able to be formed on the forming surface of the cutting tool. This allows a three-dimensionally complex shaped component to be manufactured and then trimmed. The cutting edge itself does not have to be straight, but is able to have a variable course, adapted to the shape geometry of the component to be produced later.

As the lowering movement continues and the lower dead center is reached, a mold cavity is formed between the upper tool and the lower tool. After completion of the forging process, the forming surface of the cutting tool is no longer part of the mold cavity. The cutting operation then takes place. In this sense, the cutting edge of the cutting tool is the outer boundary of the mold cavity. By carrying out the cutting movement, the mold cavity is then limited to the outside with regard to the resulting cutting edge on the component.

The cutting tool itself is designed as a segment and is mounted in a floating manner on or in the upper tool.

The cutting tool has, for example, an elongated extension. This elongated extension is, for example, more than 15 cm, more than 20 cm, and, for example, more than 30 cm long. Thus, a long cutting edge is able to be cut with high precision using the cutting tool according to the present disclosure, with regard to the geometry as well as the material properties to be set. The longitudinal extension of the cutting tool is then also able to correspond to the length of the cutting edge.

In order for the cutting tool to be able to perform a relative movement relative to the upper tool, the cutting tool is able to be driven directly via an actuator. The actuator is a hydraulic actuator, for example a hydraulic actuating cylinder. In at least one embodiment of the present disclosure, multiple hydraulic actuating cylinders are formed. These then drive out in the direction of movement of the cutting tool.

If higher cutting forces are necessary, the cutting tool is also able to be driven via a force transducer, for example, in the form of a wedge slide. The wedge slide itself is then moved by an actuator.

The direction of movement of the cutting tool itself is essentially transverse to the press stroke direction. For example, the direction of movement of the cutting tool is oriented at an angle between 40° and 90°, for example, between 50° and 90° and between 60° and 90° between the direction of movement of the cutting tool and the press stroke direction of the hot forging tool. The press stroke direction of the hot forging tool is vertically oriented. In simple terms, the direction of movement of the cutting tool is able to be horizontally oriented or run at the angles mentioned above.

The cutting tool is still mounted floating on the upper tool. For example, the predetermined cutting geometry of the resulting cutting edge of the formed component is able to be specified by the cutting edge of the lower tool. The floating mounting of the cutting tool then enables the cutting tool to shift slightly transversely and/or vertically relative to its actual direction of movement when the cutting movement is carried out and thus to optimally adjust itself to the cutting edge of the lower tool. This enables a high level of accuracy in the cutting geometry. For example, the cutting tool itself is spring-loaded in the press stroke direction. The cutting tool is able to, for example, have an axial degree of freedom in its direction of movement or be guided axially.

The present disclosure relates to a method for producing a hot forged and press hardened component, for example, the production is carried out on the hot forming and press hardening tool described above. The method is characterized by the following steps:
heating a sheet steel blank to above Ac3 temperature,
inserting into the hot forging tool and carrying out the forming operation
reaching the lower dead center,
after reaching the lower dead center, carrying out the cutting operation by moving the cutting tool relative to the upper tool, wherein the cutting edge has a temperature between 500° C. and 700° C. at the beginning of the cutting operation and/or during the cutting operation
quenching of the formed component and removal.

This means that a sheet steel blank made of a hardenable steel alloy, for example 22 MnB5, is heated to above Ac3 temperature. This is a temperature above the austenitization temperature and is above 900° C. The sheet steel blank thus heated is then placed in the combined hot forging and press hardening tool and the forming operation is carried out. As an undesirable side effect, the thus heated sheet steel blank or the partially formed component cools down during contact with the tool surfaces. However, this is negligible. For example, the forming operation is carried out in a time of less than 3 s. The time between, for example, removal from a heating furnace, insertion into the hot forging tool and completion of the forming operation is less than 10 s.

The forming operation is the execution of the movement in the press stroke direction so that the upper tool and lower tool are together in the so-called lower dead center, i.e., no further relative movement between the upper tool and lower tool takes place and the sheet steel blank is completely formed into the desired component. According to the present disclosure, a part of the forming operation is carried out by the cutting tool itself, for example, by the forming surface of the cutting tool.

While the lower dead center is being reached or immediately after the lower dead center is reached, the cutting operation is then carried out with the cutting tool according to the present disclosure on at least one component edge to be produced, so that a cutting edge is produced on the formed component. This cutting edge has a cutting edge length which corresponds, for example, to at least 10% of the peripheral length of the formed sheet steel material. The cut is made at the edge of a component and is an edge trim. The material in the component edge, i.e., at the resulting cutting edge, has a temperature between 500° C. and 650° C., at the beginning and/or during the cutting operation. The temperature is also able to still be in the above-mentioned range after completion of the cutting operation. This is possible because the cutting tool is separately tempered due to the at least one cooling channel in the cutting movement. Immediately after completion of the cutting operation, cooling of the cutting tool is also able to produce press hardening of the outer cutting edge. The material structure to be set, also in the region of the cutting edge, is thus able to be manufactured reliably and in a way that is suitable for large-scale production.

After completion of the forming operation and/or after completion of the trimming operation, the entire component is then press hardened in the hot forging and press hardening tool. Here, an appropriate cooling medium is passed through the upper tool and the lower tool so that at least a partial, to complete, martensite transformation of the formed and trimmed component is achieved.

The cutting operation itself is carried out completely. The separated part is then disposed of via appropriate scrap removal or disposal. However, according to the present disclosure, in at least one embodiment, the cutting operation is only carried out partially. This means that at least 50% of the wall thickness of the formed component is cut through. In a later processing step, the remaining wall thickness is then cut off in a final cutting operation.

### BRIEF DESCRIPTION OF THE DRAWINGS

Further advantages, features, properties, and aspects are the subject matter of the following description. Various embodiments are shown in schematic figures. These simplify the understanding of the present disclosure. In the figures:

FIG. 1 shows a hot forging and press hardening tool according to at least one embodiment of the present disclosure in the open state with a sheet metal blank inserted,

FIG. 2 shows the tool in partially closed state according to at least one embodiment of the present disclosure,

FIG. 3 shows the tool at lower dead center according to at least one embodiment of the present disclosure,

FIG. 4 shows the tool at lower dead center after trimming movement has been performed according to at least one embodiment of the present disclosure,

FIG. 5A-FIG. 5D show an example of the closing of the hot forging tool and the execution of a cutting movement according to at least one embodiment of the present disclosure,

FIG. 6 shows a different movement of the cutting tool by means of a direct actuator or a wedge slide according to at least one embodiment of the present disclosure,

FIG. 7 shows the cutting tool according to at least one embodiment of the present disclosure according to the section line A-A from FIG. 6.

### DETAILED DESCRIPTION

In the figures, the same reference numerals are used for same components, although a repeated description is omitted for reasons of simplicity.

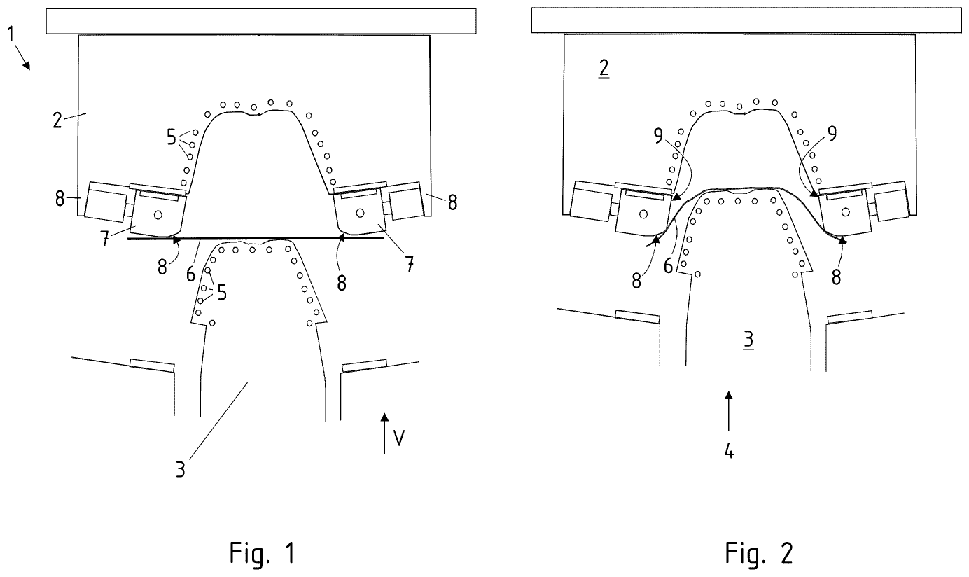

FIG. 1 shows a hot forging and press hardening tool 1 according to the present disclosure in the open state. This has an upper tool 2 and a lower tool 3. The upper tool 1 is designed as a die, the lower tool 3 as a counter-die. In relation to the vertical direction V, the lower tool 3 is raised in the press stroke direction 4. However, within the scope of the present disclosure, the lower tool 3 is able to be fixedly arranged and the upper tool 2 is lowered onto the lower tool 3 or sunk into the lower tool 3.

This movement takes place in the press stroke direction 4. Upper tool 2 and lower tool 3 each have cooling channels 5.

An inserted sheet steel blank 6, hereinafter also referred to as sheet metal blank, is placed on the lower tool 3. Respective cutting tools 7 according to the present disclosure are arranged on the left and right sides of the upper tool 2. A respective cutting tool 7 is arranged in the region of an outer edge of the upper tool 2. The cutting tool 7 has a forming surface 8 directed in the press stroke direction 4.

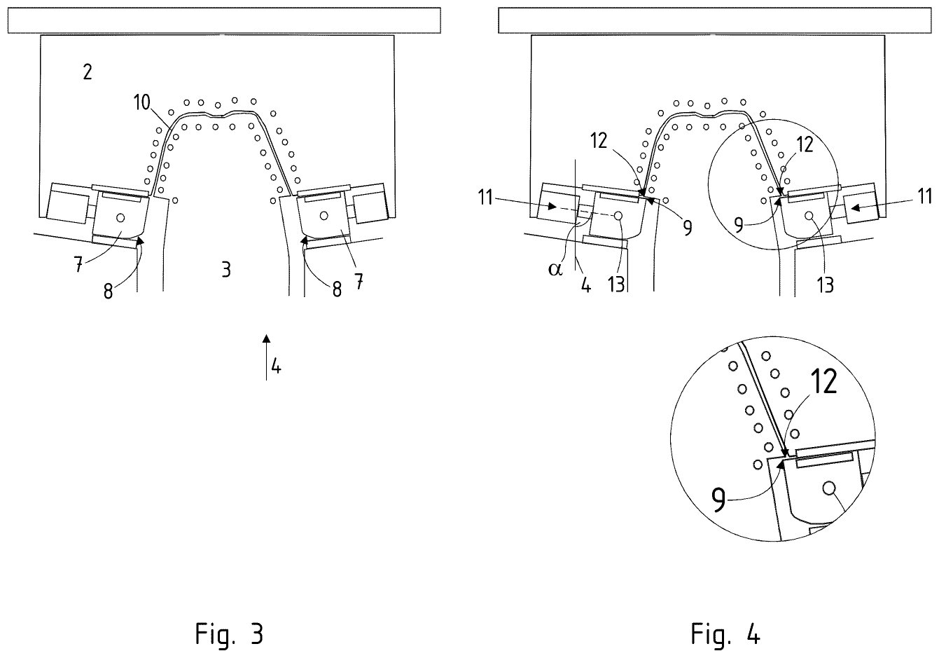

According to FIG. 2, the lower tool 3 has been raised in the press stroke direction 4. The blank bends around the forming surface 8 of the cutting tool 7 in the press stroke direction 4, then follows the cutting edge 9 described in more detail in FIG. 4. By further moving together in the press stroke direction 4, the position shown in FIG. 3 is then assumed. This is then the lower dead center. Thus, upper tool 2 and lower tool 3 are completely closed in the press stroke direction 4. This results in a mold cavity 10 and within the mold cavity 10 an almost full-surface contact of a blank, not shown in detail. The cutting tool 7, for example, the forming surface 8 of the cutting tool 7, no longer rests on the blank, not shown in detail.

Immediately upon reaching or immediately after reaching the lower dead center, the cutting tool 7 then executes a movement in the direction of movement 11. This direction of movement 11 is arranged at an angle α of 40° to 90° with respect to the press stroke direction 4.

The cutting edge 12 of the cutting tool 7 corresponds to a cutting edge 9 of the lower tool 3. As a result, a piece of sheet metal protruding therefrom is cut off, and thus separated, due to the cutting movement 11 or shearing movement.

A cooling channel 5 is arranged in the cutting tool 7 itself. Due to this at least one cooling channel 5, the temperature of the cutting tool 7 is then able to be adjusted. The cutting tool 7 is able to, for example, have residual heat, so that until the start of the cutting process, the sheet metal blank resting on the cutting tool 7 is only insignificantly cooled, but is not hardened at least partially in this region, so that the cutting process is able to be carried out in the soft region or unhardened region.

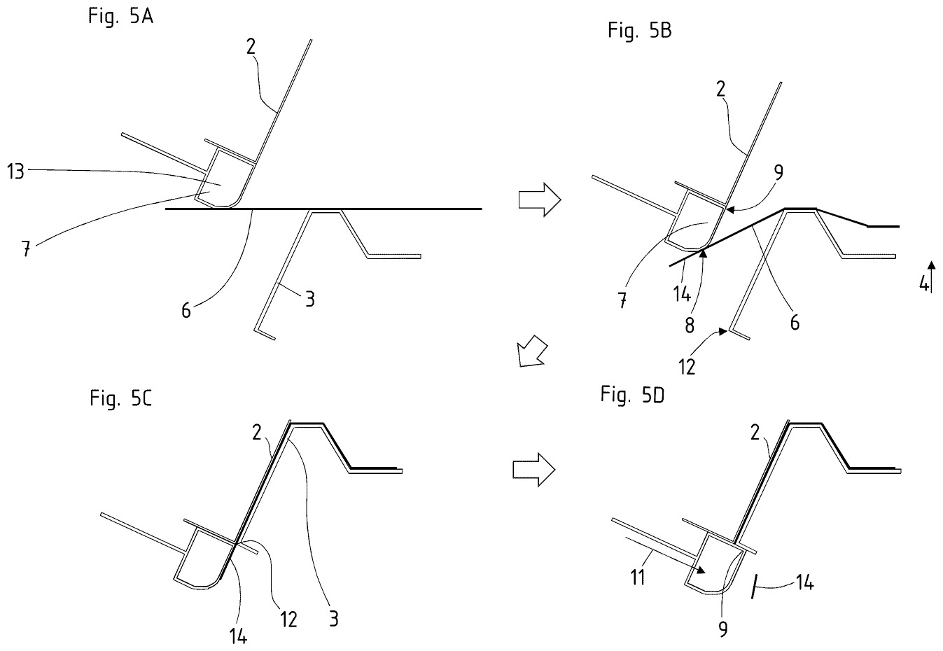

FIG. 5A to FIG. 5D show the process from FIG. 1 to FIG. 4 again in a detailed view. According to FIG. 5A, a sheet steel blank 6 is placed on the lower tool 3. The lower tool 3 is then moved into the upper tool 2 in the press stroke direction 4 so that the forging process begins, shown in FIG. 5B. The outer part of the sheet steel blank 6 is then bent. For example, this occurs due to a contact on the forming surface of the cutting tool 7. In FIG. 5C, the forging process is finished. Upper tools 2 and lower tools 3 have moved into each other and are at the lower dead center. The external part of the sheet steels, in the case of the formed component, protrudes outwards from the mold cavity 10.

According to FIG. 5D, the cutting tool 7 is then moved in the direction of movement 11 and cuts the external part from the formed component. This occurs due to a corresponding cutting movement when the cutting edge 12 of the cutting tool 7 passes the cutting edge 12 of the lower tool 3, thus executing the cutting movement.

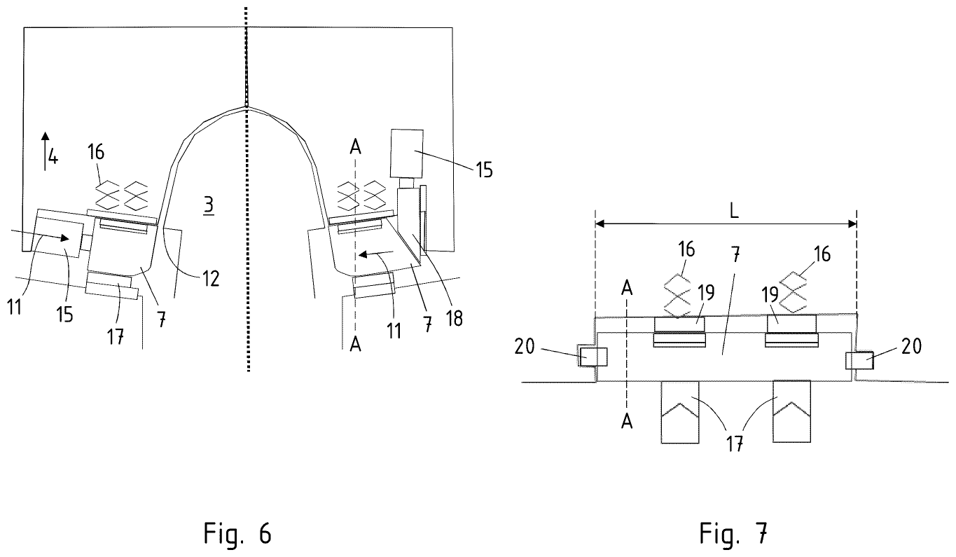

FIG. 6 shows, on the left side of the image plane, a cutting tool 7 directly driven by an actuator 15, also shown in FIG. 1 to FIG. 4. This is able to be, for example, a hydraulic cylinder. The actuator 15 moves the cutting tool 7 directly in the direction of movement 11. For this purpose, the cutting tool 7 is floatingly mounted on the upper tool 2. In the press stroke direction 4, the cutting tool 7 is able to be spring-mounted, for example, via spring elements 16, so that a certain amount of play in the press stroke direction 4 is possible. During a subsequent cutting movement, the cutting edge 12 of the lower tool 3 is able to be passed with corresponding precision. When the lower dead center is reached, the cutting tool 7 is able to rest on a lower slide rail 17, which is able to be fastened, for example, to a part of the lower tool 3, so as to be guided on the slide rail 17 and on the upper side by spring mounting.

If increased forming forces are necessary, the movement is able to be translated into the direction of movement 11 by means of a wedge slide 18, so that higher forces are able to be applied to carry out the cut. This is the case, for example, if the cutting edge extends into the image plane over more than 20 cm, for example, more than 30 cm. The wedge slide 18 itself is also able to be driven by an actuator 15. However, due to the transmission ratio between the wedge slide 18 and the cutting tool 7, a higher cutting force is able to be applied.

Within the scope of the present disclosure, both drives are also able to be combined, if, for example, two cutting tools 7 are coupled to the upper tool 2 and one cutting tool 7 only has to apply low cutting forces due to a short cutting edge created on the component. Another cutting tool 7, however, requires an increased cutting force, for example, with a cutting edge of more than 20 cm, for example, more than 30 cm.

FIG. 7 shows a sectional view along the section line A-A from FIG. 6. The cutting tool 7 is able to be seen, which has a corresponding length L. This length L corresponds to the length L of the cutting edge to be produced on a component is able to, for example, be more than 20 cm, for example, more than 30 cm long. The cutting tool 7 is mounted in the upper tool 2 in the press stroke direction via spring means 16. The cutting tool 7 is also able to have an upper slide rail 19 between the spring means 16 and the upper tool 2. The cutting tool 7 is mounted on a lower tool 3 on corresponding slide rails 17 and rests on them. Further axial guide elements 20 may be provided.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-12. (canceled)

13. A hot forging and press hardening tool, comprising:
an upper tool and a lower tool configured to move towards one another in a press stroke direction;
a mold cavity formed between the upper tool and the lower tool in a closed state;
a plurality of cooling channels for passage of a cooling medium, in the upper tool and the lower tool; and
a cutting tool, which is movable relative to the upper tool, arranged on the upper tool, wherein
the cutting tool has at least one cooling channel of the plurality of cooling channels for temperature control, and
the cutting tool comprises
a forming surface oriented in the press stroke direction, and
a cutting edge adjacent to the forming surface.

14. The hot forging and press hardening tool according to claim 13, wherein the cutting tool is arranged in an edge region of the upper tool.

15. The hot forging and press hardening tool according to claim 13, further comprising:
a further cutting edge on the lower tool and configured to perform a cutting movement with the cutting tool.

16. The hot forging and press hardening tool according to claim 13, wherein the forming surface is a rounded edge.

17. The hot forging and press hardening tool according to claim 13, wherein the cutting tool is a segment comprising an elongated extension of more than 15 cm.

18. The hot forging and press hardening tool according to claim 13, further comprising:
an actuator configured to directly drive the cutting tool.

19. The hot forging and press hardening tool according to claim 13, wherein a direction of movement of the cutting tool is oriented relative to the press stroke direction at an angle between 40° and 90°.

20. The hot forging and press hardening tool according to claim 13, wherein the cutting tool is mounted floatingly on the upper tool.

21. The hot forging and press hardening tool according to claim 13, wherein the cutting tool is spring-elastically mounted in the press stroke direction.

22. A method of making a hot forged and press hardened component, the method comprising:
heating a sheet steel blank to above Ac3 temperature;
inserting the sheet steel blank into a hot forging and press hardening tool, the hot forging and press hardening tool comprising:
an upper tool and a lower tool configured to move towards one another in a press stroke direction;
a mold cavity formed between the upper tool and the lower tool in a closed state;
a plurality of cooling channels for passage of a cooling medium, in the upper tool and the lower tool; and
a cutting tool, which is movable relative to the upper tool, arranged on the upper tool, wherein the cutting tool has at least one cooling channel of the plurality of cooling channels for temperature control, and the cutting tool comprises
a forming surface oriented in the press stroke direction, and
a cutting edge adjacent to the forming surface;
performing a forming operation by moving the upper tool and the lower tool towards one another in the press stroke direction until reaching a lower dead center;
after reaching the lower dead center, performing a cutting operation by moving the cutting tool relative to the upper tool, wherein the cutting edge has a temperature between 500° C. and 700° C. at the beginning of or during the cutting operation; and
quench hardening the formed component at least in sections, and removing the hardened and formed component from the hot forging and press hardening tool.

23. The method according to claim 22, wherein the cutting operation is performed completely.

24. The method according to claim 22, wherein a tensile strength Rm greater than 1350 MPa is set in a cut edge of the component, by the quench hardening after the cutting operation.

25. The hot forging and press hardening tool according to claim 13, wherein the forming surface changes in a longitudinal direction of the cutting tool.

26. The hot forging and press hardening tool according to claim 13, wherein the cutting tool is a segment comprising an elongated extension of more 20 cm.

27. The hot forging and press hardening tool according to claim 13, wherein the cutting tool is a segment comprising an elongated extension of more 30 cm.

28. The hot forging and press hardening tool according to claim 13, further comprising:
a wedge slide; and
an actuator configured to drive the cutting tool via the wedge slide.

29. The hot forging and press hardening tool according to claim 13, wherein a direction of movement of the cutting tool is oriented relative to the press stroke direction at an angle between 50° and 90°.

30. The hot forging and press hardening tool according to claim 13, wherein a direction of movement of the cutting tool is oriented relative to the press stroke direction at an angle between 60° and 90°.

31. The hot forging and press hardening tool according to claim 13, wherein the cutting edge lies behind the forming surface in the press stroke direction.

32. The method according to claim 22, wherein the cutting operation is performed to at least 50% based on a wall thickness of the formed component.
